(19) United States
(12) Patent Application Publication
(10) Pub. No.: US 2007/0295453 A1
(43) Pub. Date: Dec. 27, 2007

(54) Instrument Panel Assembly and Method of Forming Same

(76) Inventors: Hein J. Koelman, Konigsberg (DE); Gerhard Slik, Eggenstein-Leopoldshafen (DE)

Correspondence Address: DOBRUSIN & THENNISCH PC, 29 W. LAWRENCE STREET, STE. 210, PONTIAC, MI, 48342, US

(21) Appl. No.: 10/545,282

(22) PCT Filed: Feb. 11, 2004
(86) PCT No.: PCT/US04/03857

§ 371 Date: Mar. 22, 2007

Related U.S. Application Data
(60) Provisional application No. 60/447,117, filed on Feb. 13, 2003.

(51) Int. Cl. C09J 5/00; B60K 37/00; B62D 25/14; B62D 27/02

(52) U.S. Cl. 156/331.8; 156/334; 156/60

(57) ABSTRACT

An instrument panel assembly (10) is provided for an article of manufacture such as an automotive vehicle. The assembly (10) typically includes at least one framework structure (12) and at least one construction (18). The framework structure (12) and the construction (18) are typically attached (e.g., adhesively secured) to each other in a manner that assists in the formation of at least a portion of a system such as a heating, ventilating and air conditioning (HVAC) system.

### CLAIM OF BENEFIT OF FILING DATE

The present application claims the benefit of the filing date of U.S. Provisional Application Ser. No. 60/447,117, filed Feb. 13, 2003, hereby incorporated by reference.

### TECHNICAL FIELD

The present invention relates to an improved instrument panel assembly and method of forming the same. More particularly, the present invention relates to an improved instrument panel assembly suitable for assembly to an automotive vehicle.

### BACKGROUND OF INVENTION

Generally, the transportation industry has sought to form assemblies for transportation vehicles that exhibit structural integrity, relatively low weight or both. For example, it may be desirable for intrument panel assemblies of automotive vehicles to be self-supporting and additionally, it may be desirable for such assemblies to a least partially support one or more additional components such as air bag assemblies, instruments, fuse boxes, steering columns or the like. At the same time, it is preferable for the instrument panel assemblies to maintiain a low weight to assist in maintaining an overall lower weight for the vehicle.

Moreover, it may also be desirable for an instrument panel assembly to be constructed in a manner suitable for accommodating various functional components such as heating, ventilation and air conditioning (HVAC) ducts, electrical wiring or the like.

Accordingly, the present invention provides an assembly, and more particularly an instrument control panel assembly that exhibits relatively low weight, structural integrity, design flexibility or a combination thereof.

### SUMMARY OF THE INVENTION

The present invention provides an instrument panel assembly having at least one framework structure and at least one construction (e.g., a panel or trim construction). The at least one construction is preferably formed of a plastic material and can be formed of a low surface energy plastic material and/or can be formed of a material including polypropylene, polyamide, a styrenic, a competitor grade material or a combination thereof. The at least one framework structure is preferably formed of a metal and more preferably a mild steel, an extruded aluminum, a die cast magnesium, a combination thereof or the like.

According to one preferred aspect of the present invention, the at least one framework structure is at least partially attached (e.g., adhered) to the at least one construction with an adhesive. The adhesive may be chosen from a variety of adhesives that are described herein. In one preferred embodiment, the adhesive is capable of bonding to both metal and a plastic.

### DESCRIPTION OF THE DRAWINGS

FIG. 1 is an exploded perspective view of an exemplary instrument panel assembly according to an aspect of the present invention.

FIG. 2A is an assembled sectional view of a portion of the instrument panel assembly of FIG. 1.

FIG. 2B is another assembled sectional view of a portion of the instrument panel assembly of FIG. 1.

FIG. 3 is an exploded perspective view of a portion of an instrument panel assembly according to an alternative aspect of the present invention.

FIG. 4 is an assembled perspective view of a portion of an instrument panel assembly according to another alternative aspect of the present invention.

FIG. 5 is an exploded perspective view of an instrument panel assembly according to an alternative aspect of the present invention.

FIG. 6A-6C are sectional views of exemplary ducts formed in accordance with an aspect of the present invention.

### DETAILED DESCRIPTION OF THE PREFERRED EMBODIMENT

The present invention is predicated upon the provision of an instrument panel assembly having at least one framework structure and at least one construction (e.g., a panel or trim construction). Preferably, the at least one framework structure and at least one construction are formed of different materials although they may be formed of same or similar materials. One or more of the materials can have a relatively low energy surface. It is also preferable for the framework stucture to be at least partially secured to the construction with an adhesive. Advantageously, such adhesive securing can still be accomplished if one or both of the at least one framework structure and at least one construction provides a low energy surface to be bonded or if higher energy surfaces are provided.

It is contemplated that the instrument panel assembly of the present invention may be employed for various articles of manufacture such as radios, electronics, stereo systems or the like. It has been found, however, that the assembly is quite effective for transportion vehicles (e.g., automotive vehicles). It is contemplated that the assembly can assisting in supporting or may be integrated with one or more of a radio housings, a navigation system, climate control devices, glovebox components (e.g., a glovebox bin), an air bag canister, an instrument cluster, an electronic box, an electronic module, combinations thereof or the like.

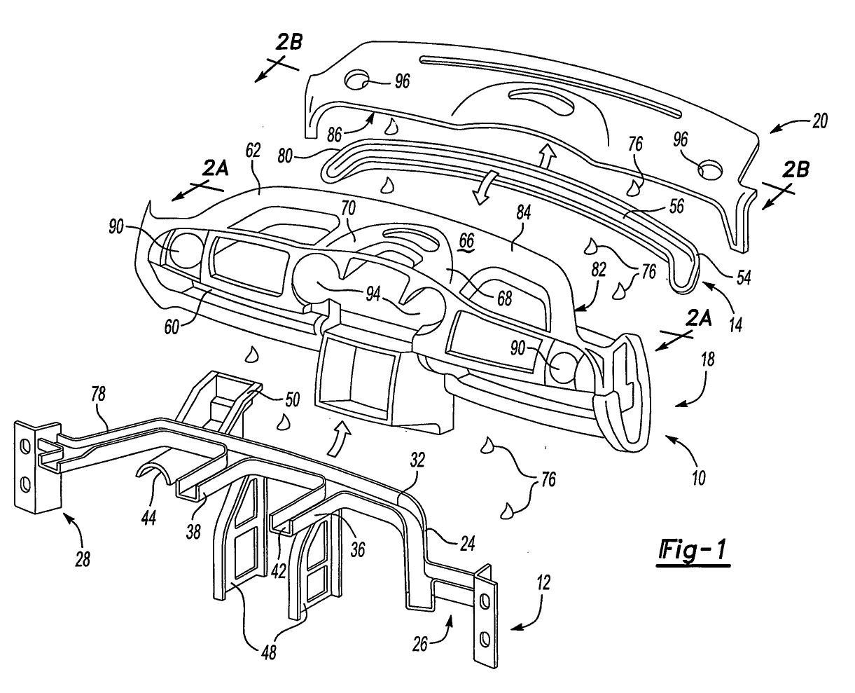

Referring to FIG. 1, there is illustrated an exemplary instrument panel assembly 10 in accordance with the present invention. The assembly 10 preferably includes at least one framework structure and at least one construction. The assembly 10 illustrated includes a first framework structure 12, a second framework structure 14, a first construction 18 and a second construction 20.

The first framework structure 12 may be configured in a variety of shapes and sizes. In the embodiment shown, the first framework structure 12 includes an elongated member 24 extending from a first end 26 to a second end 28. The member 24 is designed to substantially extend form one A-pillar of an automotive vehicle to an opposite A-pillar of the vehicle. As such, each end 26, 28 includes an attachment portion configured for securing the member 24 to the A-pillars (not shown). Preferably, the member 24 defines a channel 32 that is substantially coextensive with the member 24. It should be understood that channels according to the present invention may be formed by many techniques including deforming, bending, rolling, combinations thereof or the like.

The illustrated first framework structure 12 also includes a first extension 36 and a second extension 38, both of which extend outwardly from the elongated member 24. Preferably, the first extension 36 extends substantially parallel to the second extension 38. Moreover, it is preferable that the first extension 36 and second extension 38 respectively to define sub-channels 42, 44, which are connected to the channel 32 of the elongated member 24.

The first framework structure 12 optionally includes one or more supports for assisting in supporting the elongated member 24. As shown, the first structure 12 includes a pair of supports 48 extending outward from the elongated member 24. It is also contemplated that first framework structure 12 may include a support structure 50, which may be employed for assisting in supporting a steering column (not shown) or other component of the automotive vehicle.

The second framework structure 14 includes only an elongated member 54 but may be configured to include other structures as well. As shown, the elongated member 54 of the second framework structure 14 defines a channel 56 in a manner similar to the elongated member 24 of the first structure 12.

The first construction 18 may be formed in a variety of shapes and configurations depending upon the automotive vehicle in which the construction 18 will be employed. In one embodiment, the first construction includes a panel portion 60 that is configured to at least partially define an instrument panel on an automotive vehicle. As shown, the panel portion 60 may include a plurality of openings (e.g., cavities or pockets) for accommodating instruments (such as a cluster, a radio, a speedometer, a air bag or the like) of an automotive vehicle.

The first construction 18 also includes a section 62 shown as a rear section extending outwardly from the panel portion 60. Preferably, the section 62 includes a first portion 66 corresponding to the elongated member 24 of the first structure 12. Additionally, the section 62 also preferably includes a second portion 68 and a third portion 70 corresponding to the extensions 36, 38 of the first structure 12.

The second construction 20, like the first, may be formed in a variety of shapes and configurations. In the illustrated embodiment, the second construction 20 is substantially configured as a panel.

In addition to the above structures and constructions, it is contemplated that the instrument panel assembly may include one or more reinforcements particularly for supporting a steering column. For example, a reinforcement member may bridge a gap between a first portion and a second portion of one or more of the structures, constructions or both. Particularly, the member may bridge a gap through which the steering column extends and may bridge the gap above or below the steering column. An example of such a reinforcement is disclosed in commonly owned U.S. patent application Ser. No. 10/403,603, titled, Instrument Panel Assembly and method of Forming Same, filed Mar. 31, 2003, which is hereby expressly incorporated by reference for all purposes.

It is contemplated that the first and second structures and the first and second constructions may be formed of a variety of different materials. Moreover, it is contemplated that various portions or components of the first and second structures and the first and second constructions may be formed of different materials. Exemplary materials include metals, polymeric materials or the like.

Preferably the constructions are formed of a plastic molding. The plastics material preferably comprises a homopolymer, for example a polyolefin, a polyamide, a polyphenylene oxide and polystyrene, or a copolymer, for example a polyalkylene terephthalate.

Preferred plastics materials include polypropylene, polyamide, polyamide alloys, polyethylene (low or high density), polyphenylene oxide polymers, polyphenylene oxide alloys, polystyrene polymers, polystyrene alloys, polybutylene terephthalate polymers, acrylonitrile butadiene styrene (ABS), polycarbonate acrylonitrile butadiene styrene PC/ABS, competitor grade plastics (e.g., styrene maleic anhydride (SMA) 7, blends of the above polymers with polyphenylene ether or polyphenylene oxide or the like) and polybutylene terephthalate alloys. The plastics material may contain fibre, for example short glass fibre, long glass fibre, short natural fibre or long natural fibre.

Especially preferred plastics materials include short glass fibre filled polypropylene, long glass fibre filled polypropylene, short fiber glass filled ABS, long glass fiber filled ABS, short glass fiber filled PC/ABS, long glass fiber filled PC/ABS, glass filled polyamide and glass filled polyamide alloys.—Plastics materials which are especially preferred for use in bumper systems as the EAU include unfilled polypropylene, talc filled polypropylene, mineral filled polypropylene]

In certain preferred embodiments, the polymeric materials may include fibers for additional strength. Although it is contemplated that fibers of various sizes (e.g., lengths) may be employed, advantageously, it has been found that relatively long glass fibers add a relatively high degree of strength. Thus, in preferred embodiments, a polymeric material such as ABS, PCABS, polypropylene or another suitable plastic is filled with glass fibers having an average length of approximately greater than 2 mm, more preferably greater than about 4 mm even more preferably greater than about 6 mm and most preferably between about 8 mm and 20 mm.

The polymers or plastics may also include a variety of fillers. Exemplary fillers include, without limitation, silica, diatomaceous earth, glass, clay, talc, pigments, colorants, carbon ceramic fibers, mica, antioxidants, and the like.

It is possible to make constructions using art-disclosed techniques for the fabrication of the material selected. Thus, for example, the constructions may be formed, molded, machined or otherwise configured to the desired shape. Where the constructions are plastic, it is possible to use any suitable plastic fabrication technique including, without limitation, injection molding (including but not limited to external or internal gas injection molding), blow molding, compression molding, rotational molding, thermoforming, extruding, vacuum forming, foaming-in-place, or otherwise. One or more other fabrication techniques can also be employed such as insert molding, over-molding or a combination thereof. Accordingly, as can be appreciated, in one embodiment, hybrid panel assemblies can be fabricated, thereby taking advantage of the benefits of different respective materials and different respective fabrication techniques, and also advantageously permitting for the ability to design additional features.

The framework structures are preferably are at least partially or substantially entirely formed of one or more metals such as aluminum, iron, tungsten, magnesium, steel, tin, copper, titanium, combinations thereof or the like. Formation of the structures may also be accomplished using a variety of techniques. For example, the structures may be roll formed, cast, stamped or the like. The structures may also be molded, extruded, or the like.

The instrument panel assembly 10 is formed, generally, by attaching the one or more framework structures to the one or more constructions. It is also contemplated that, for plural framework structures or for plural constructions, the framework structures may be attached to each other and the constructions may be attached to each other.

Any suitable fastening techniques may be employed for attaching the constructions together, the framework structures together, or attaching the framework structures to the constructions. For example, mechanical fasteners such as screws, clips, rivets, interlocking devices combinations thereof or the like may be employed. Moreover, such attachments may be integrally formed with or separate from the framework structures or constructions. Alternatively or additionally, the structures may be integrated with the constructions by molding at least a portion of the constructions about the structures according to one of the molding techniques described herein. As other alternatives or other additions, heat staking, vibrational welding, sonic welding, combinations thereof or the like may be used.

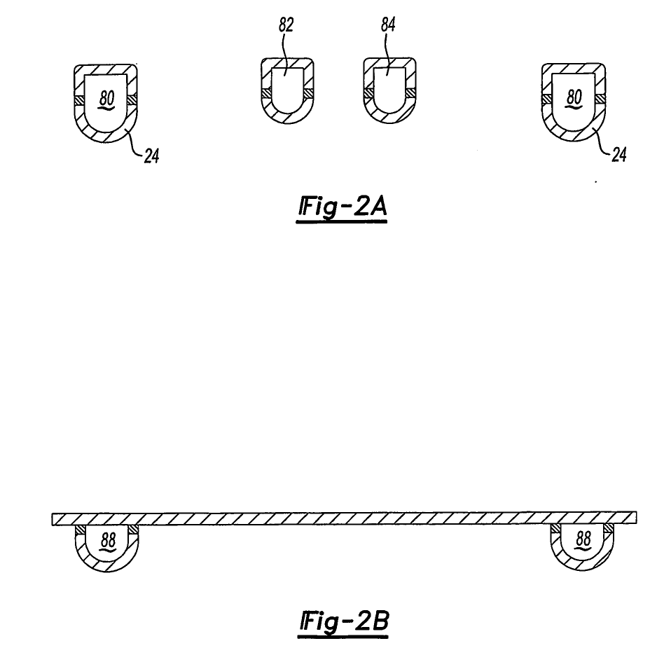

In the embodiment illustrated and with additional reference to FIGS. 2A and 2B, the first framework structure 12 is adhered to the first construction 18 and the second framework structure 14 is adhered to both the first and second constructions 18, 20. Preferably, an adhesive 76 is applied to mating or corresponding surfaces 78, 80, 82, 84, 86 of the first framework structures 12, the second framework structure 14, the first construction 18, the second construction 20 or a combination thereof. Thereafter, the mating or corresponding surfaces 78, 80, 82, 84, 86 are pressed toward each other to adhere the surfaces 78, 80, 82, 84, 86, and thus, the framework structures 12, 14 and constructions 18, 20 together.

Any suitable adhesive may be employed in the present invention. Preferably, the adhesive is compatible with (i.e., capable of adhering to) the material of the surfaces of the structures and constructions. If, however, the adhesive is slightly incompatible with one of these materials, it may be desirable to treat the surface[s] formed of the incompatible material. Exemplary treatments include the application of primer, exposure to plasma, combinations thereof or the like.

In one embodiment, the adhesive is a urethane based adhesive, and more preferably a urethane adhesive (e.g., a polyurethane adhesive). Alternatively, the adhesive may include a functional component selected from, an acrylic, methyl methacrylate (MMA), an epoxy, an acrylonitrile butadiene styrene (ABS), a polycarbonate (PC), or a mixture thereof (e.g. PC-ABS). In a further alternative embodiment the adhesive is a silane adhesive, a silicone adhesive or a mixture thereof. In yet another embodiment, the adhesive is an acrylic adhesive. The adhesive may also be epoxy based. It may include polyolefinics, styrenics, acrylics or mixtures thereof. In yet another embodiment, a preferred adhesive includes alkyl borane. Examples of suitable adhesives are disclosed in commonly owned U.S. patent Ser. No. 09/466,321 (filed Dec. 17, 1999) and patent publication numbers 20020058764 and 20030001410 expressly incorporated herein by reference for all purposes. Any such adhesive may include suitable performance modifiers including art disclosed tackifiers, elastomers, impact modifiers, or the like.

In one highly preferred embodiment, a two part, organoborane/amine comple adhesive or other adhesive is employed for adhesively securing combinations of the constructions and the framework structuring together. Advantageously, it has been found that the adhesive is compatible with metal (e.g., steel) and plastic, particularly polypropylene. As such, the adhesive may be used for attaching the framework structures, when formed of metal, to the constructions, when formed of plastic or polypropylene, without having to treat any surfaces of the constructions or surfaces prior to adhesion.

An especially preferred embodiment of the invention provides one or more constructions made of a molded glass filled polypropylene and/or glass filled polyamide having a surface energy of less than 45 mJ/m², and a reinforcement made from steel, zinc and/or aluminium. As such, the adhesive which is preferably capable of bonding to a substrate having a surface energy of less than 45 mJ/m² is disposed between at least part of the corresponding surfaces so as to bond them together, the adhesive being derived from a polymerizable composition comprising

i) an organoborane/amine complex;

ii) one or more of monomers, oligomers or polymers having olefinic unsaturation which is capable of polymerization by free radical polymerization; and, optionally

iii) a compound which causes the said complex to disassociate so as to release the borane to initiate polymerization of one or more of monomers, oligomers or polymers having olefinic unsaturation.

Of course, it is contemplated that other plastics or metals having higher surface energies may be employed depending on the adhesive to be used, and depending on other factors (e.g., cost, weight, etc.).

Additional especially preferred aspects of the invention are a method of making the automobile assembly referred to in the preceding paragraph and use of an adhesive described in that paragraph in fabricating the assembly described in it.

Adhesives and polymerizable compositions disclosed in International Patent Application No. PCT/US00/33806 are especially preferred for use in the present invention to bond the constructions and structures.

The amines used to complex the organoborane compound can be any amines which complex the organoborane and which can be decomplexed when exposed to a decomplexing agent. Preferred amines include the primary or secondary amines or polyamines containing primary or secondary amine groups, or ammonia, as disclosed in Zharov U.S. Pat. No. 5,539,070 at column 5 lines 41 to 53, incorporated herein by reference, Skoultchi U.S. Pat. No. 5,106,928 at column 2 line 29 to 58 incorporated herein by reference, and Pocius U.S. Pat. No. 5,686,544 column 7, line 29 to Column 10 line 36 incorporated herein by reference; monthanolamine, secondary dialkyl diamines or polyoxyalkylenepolyamines; and amine terminated reaction products of diamines and compounds having two or more groups reactive with amines as disclosed in Deviny U.S. Pat. No. 5,883,208 at column 7 line 30 to column 8 line 56, incorporated herein by reference. With respect to the reaction products described in Deviny the preferred diprimary amines include alkyl diprimary amines, aryl diprimary amines, alkyaryl diprimary amines and polyoxyalkylene diamines; and compounds reactive with amines include compounds which contain two or more groups of carboxylic acids, carboxylic acid esters, carboxylic acid halides, aldehydes, epoxides, alcohols and acrylate groups. Preferred amines include n-octylamine, 1,6-diaminohexane (1,6-hexane diamine), diethylamine, dibutyl amine, diethylene triamine, dipropylene diamine, 1,3-propylene diamine (1,3-propane diamine), 1,2-propylene diamine, 1,2-ethane diamine, 1,5-pentane diamine, 1,12-dodecanediamine, 2-methyl-1,5-pentane diamine, 3-methyl-1,5-pentane diamine, triethylene tetraamine, diethylene triamine. Preferred polyoxyalkylene polyamines include polyethyleneoxide diamine, polypropyleneoxide diamine, triethylene glycol propylene diamine, polytetramethyleneoxide diamine and polyethyleneoxidecopolypropyleneoxide diamine.

In particular, the amine in the organoborane/amine complex is suitably selected from the group of amines having an amidine structural component; aliphatic heterocycles having at least one nitrogen in the heterocyclic ring wherein the heterocyclic compound may also contain one or more nitrogen atoms, oxygen atoms, sulphur atoms, or double bonds in the heterocycle; primary amines which in addition have one or more hydrogen bond accepting groups wherein there are at least two carbon atoms, preferably at least three carbon atoms, between the primary amine and the hydrogen bond accepting group, such that due to inter- or intramolecular interactions within the complex the strength of the B—N bond is increased; and conjugated imines.

Preferred hydrogen bond accepting groups include the following: primary amines, secondary amines, tertiary amines, ethers, halogens, polyethers or polyamines. Heterocycle as used herein refers to a compound having one or more aliphatic cyclic rings of which one of the rings contains nitrogen. The amidines or conjugated imines may be straight or branched chain or cyclic.

Desirably, the organoborane used in the complex is a trialkyl borane or an alkyl cycloalkyl borane. Preferably this borane corresponds to Formula 1:
B—(R¹)₃ Formula 1
wherein B represents boron; and R¹ is separately in each occurrence a C₁₋₁₀ alkyl, C₃₋₁₀ cycloalkyl, or two or more of R¹ may combine to form a cycloaliphatic ring.

Preferably R¹ is C₁₋₄ alkyl, even more preferably C₂₋₄ alkyl and most preferably C₃₋₄ alkyl. Among preferred organoboranes are tri-ethyl borane, tri-isopropyl borane and tri-n-butylborane.

In a preferred embodiment, the amine part of the complex comprises a compound having a primary amine and one or more hydrogen bond accepting groups, wherein there are at least two carbon atoms, preferably at least about three, between the primary amine and hydrogen bond accepting groups.

Preferably, the amine corresponds to Formula 2:
NH₂(CH₂)_{b}(C(R²)₂)_{aX} (2)
wherein R² is separately in each occurrence hydrogen or a C₁₋₁₀ alkyl or C₃₋₁₀ cycloalkyl; X is hydrogen bond accepting moiety; a is an integer of 1 to 10; and b is separately in each occurrence an integer of 0 to 1, and the sum of a and b is from 2 to 10.

Preferably R² is hydrogen or methyl.

Preferably X is separate in each occurrence a hydrogen accepting moiety and, when the hydrogen accepting moiety is an amine, it is preferably a tertiary or a secondary amine. More preferably X is separately in each occurrence —N(R²)ₑ, —OR₁₀, or a halogen wherein R₈ is separately in each occurrence C₁₋₁₀ alkyl, C₃₋₁₀ cycloalkyl or —(C(R²)₂)_{d}—W; R₁₀ is separately in each occurrence, C₁₋₁₀ alkyl, C₃₋₁₀ cycloalkyl, or —(C(R²)₂)_{d}—W; and e is 0, 1, or 2. More preferably X is —N(R₈)₂ or —OR₁₀.

Preferably, R₈ and R₁₀ are C₁₋₄ alkyl or —(C(R¹)₂)_{d}—W, more preferably C₁₋₄ alkyl and most preferably methyl. W is separately in each occurrence hydrogen or C₁₋₁₀ alkyl or X and more preferably hydrogen or C₁₋₄ alkyl.

Preferably, a is about 1 or greater and more preferably 2 or greater. Preferably, a is about 6 or less, and most preferably about 4 or less. Preferably, b is about 1. Preferably, the sum of a and b is an integer about 2 or greater and most preferably about 3 or greater. Preferably the sum of a and b are about 6 or less and more preferably about 4 or less. Preferably d is separately in each occurrence an integer of 1 to 4, more preferably 2 to 4, and most preferably 2 to 3.

Among preferred amines corresponding to Formula 2 are dimethylaminopropyl amine, methoxypropyl amine, dimethylaminoethylamine, dimethylaminobutylamine, methoxybutyl amine, methoxyethyl amine, ethoxypropylamine, propoxypropylamine, amine terminated polyalkylene ethers (such as trimethylolpropane tris(poly(propyleneglycol), amine terminated)ether), aminopropylmorpholine, isophoronediamine, and aminopropylpropanediamine.

In another embodiment, the amine may be an aliphatic heterocycle having at least one nitrogen in the heterocycle. The heterocyclic compound may also contain one or more of nitrogen, oxygen, sulfur or double bonds. In addition, the heterocycle may comprise multiple rings wherein at least one of the rings has a nitrogen in the ring. Preferred compounds of this type include morpholine, piperidine, pyrolidine, piperazine, 1,3,3 trimethyl 6-azabicyclo[3,2,1]octane, thiazolidine, homopiperazine, aziridine, 1,4-diazabicylo[2.2.2]octane (DABCO), 1-amino-4-methylpiperazine, and 3-pyrroline.

In yet another embodiment, the amine which is suitably complexed with the organoborane is an amidine. Any compound with amidine structure wherein the amidine has sufficient binding energy as described hereinbefore with the organoborane, may be used. Among preferred amidines are 1,8 diazabicyclo[5,4]undec-7-ene; tetrahydropyrimidine; 2-methyl-2-imidazoline; and 1,1,3,3-tetramethylguanidine.

In a further embodiment, the amine which is complexed with the organoborane is suitably a conjugated imine. Any compound with a conjugated imine structure, wherein the imine has sufficient binding energy with the organoborane as described in International Patent Application No. PCT/US00/33806 may be used. The conjugated imine can be a straight or branched chain imine or a cylic imine. Among preferred conjugated imines are 4-dimethylaminopyridine; 2,3-bis(dimethylamino)cycl-opropeneimine; 3-(dimethylamine)acroleinimine; 3-(dimethylamino)methacrole-inimine.

Preferably the molar ratio of amine compound to organoborane compound is from 1.0:1.0 to 3.0:1.0. Below the ratio of about 1.0:1.0 there may be problems with polymerization, stability of the complex and adhesion. Greater than about a 3.0:1.0 ratio may be used although there may not be additional benefit from using a ratio greater than about 3.0:1.0. If too much amine is present, this may negatively impact the stability of the adhesive or polymer compositions. Preferably the molar ratio of amine compound to organoborane compound is from 2.0:1.0 to 1.0:1.0.

The organoborane amine complex may be readily prepared using known techniques, for example as described or referred to in International Patent Application No. PCT/US00/33806.

Preferably, the polymerizable material comprises acrylate and/or methacrylate based compounds. Especially preferred acrylate and methacrylate compounds include methylmethacrylate, butylmethacrylate, ethylhexylmethacrylate, isobornylmethacrylate, tetrahydrofurfuryl methacrylate, and cyclohexylmethylmethacrylate.

The polymerizable composition may further comprise an effective amount of a compound that is reactive with an amine so as to liberate the organoborane so as to initiate polymerization (a disassociating agent). Desirable amine reactive compounds are those materials that can readily form reaction products with amines at or below and more preferably at room temperature so as to provide a composition that can be generally easily used and cured under ambient conditions. General classes of these compounds include acids, aldehydes, isocyanates, acid chlorides, sulphonyl chlorides, mixtures thereof and the like. Preferred amine reactive compounds are acids, especially Bronsted and Lewis acids and those described in U.S. Pat. No. 5,718,977 and, more desirably acrylic acid and methacrylic acid.

In the polymerizable composition, suitably at least 20% by weight, preferably at least 30% by weight and especially at least 40% by weight of the composition comprises the polymerizable component. Independently, the polymerizable component is suitably present at a level not exceeding 95%, preferably not exceeding 90% and especially not exceeding 85% by weight of the composition.

Suitably, the organoborane/amine complex is present at a level of at least 0.2%, preferably at least 1% and more preferably at least 2% by weight of the composition. Independently, the complex is suitably present at a level not exceeding 8%, preferably not exceeding 6% and especially not exceeding 4% by weight of the composition.

If present, the disassociating compound is present at a level of at least 1%, preferably at least 1.5% and more preferably at least 2% by weight of the composition. Independently, the disassociating compound is suitably present at a level not exceeding 8%, preferably not exceeding 6% and especially not exceeding 4% by weight of the composition.

The adhesive to be employed in the present invention suitably is capable of providing a bond between a 30% glass filled polypropylene construction and the structure without the construction having been subjected to any surface treatment when tested in accordance with the procedure set out in ASTM D1002. Preferably, the adhesive provides a bond when tested under this regime including in addition being subjected to thermal cycling and high humidity. Thermal cycling in this context suitably includes cycling over a range from −40.degree. C. to greater than 120.degree. C. Humidity levels can vary from dry to fully saturated.

The adhesive may be used in the manner set out in International Patent Application No. PCT/US00/33806. Optionally, further components may be included as additives in the composition. Suitable additives include those set out in International Patent Application No. PCT/US00/33806.

The assembly suitably is able to withstand exposure to heat at a temperature of 100° C. and suitably at up to 120° C. or more. Further, the assembly desirably should also be able to withstand loads applied during production and also imposed in use.

Once the adhesive 76 has been applied, it will typically require some amount of time to cure (e.g., part cure, full cure, cure on demand, air cure, heat cure, moisture cure, chemical cure, light cure, or the like). Preferably, the adhesive cures at about room temperature (e.g., between about 20° C. to about 30° C.), but may be exposed to elevated or lowered temperatures for accelerating or slowing cure times. During cure, it may be desirable to employ fasteners (e.g., push-pins, clips or the like) for holding the constructions, structures, or both together. Such fasteners may be removable or may be intended to assist in securing the constructions and structures together during use of the panel assembly 10.

Generally, it is desirable for the adhesive to exhibit a reasonable amount of post-cure ductility. Preferably, the adhesive exhibits ductility that is as high as the ductility of material that forms the structures 12, 14 or the material that forms the constructions 18, 20, whichever ductility is lower. More preferably, however, the adhesive exhibits ductility that is as high as the ductility of material that forms the structures 12, 14 or the material that forms the constructions 18, 20, whichever ductility is higher.

Upon attachment of the framework structures to the constructions, one or more ducts are preferably formed by the structures the constructions or a combination thereof. With additional reference to FIGS. 2A and 2B, it can be seen that the first framework structure 12 and the first construction 18 cooperatively form one or more air ducts 80, 82, 84 and the second framework structure 14 and the second construction 20 cooperatively form one or more air ducts 88. Preferably, the ducts 80, 82, 84, 88 are employed as part of the HVAC system of the automotive vehicle. As such, the ducts 80, 82, 84, 88 are preferably in fluid communication with a source (not shown) of conditioned air.

In the preferred embodiment illustrated, the elongated member 24 of the first framework structure 12 and the first portion 66 of the rear section 62 cooperatively enclose the channel 32 to form a duct 80 that provides fluid communication between the source of conditioned air and a pair of outer openings 90 in the panel portion 60 of the first construction 18. Moreover, the second and third portions 68, 70 of the rear section 62 and the first and second extensions 36, 38 of the first framework structure 12 respectively cooperatively enclose the sub-channels 42, 44 to form ducts 82, 84 that provide fluid communication between the source of conditioned air and a pair of inner openings 94. Preferably the inner openings 94 and the outer openings 90 are defined by the panel portion 60 of the first construction 18, although not required.

Also in the illustrated embodiment, the elongated member 54 of the second framework structure 14 and the second construction 20 cooperatively enclose the channel 56 to form another duct 88 that provides fluid communication between the source of conditioned air and an upper pair of openings 96. Preferably, the upper pair of openings 96 are defined by the second construction 20.

Although not required, it may be desirable to cover surfaces (e.g., of the constructions, the framework structures or both), which defines the ducts for preventing corrosion, condensation or the like. Suitable coverings may include coatings such as paints, primers or the like. Alternatively, films or or other coverings of plastic or polymeric material may also be employed to coat the surfaces. In one preferred embodiment, the covering is a blow molded polymeric material, which may be any one of the polymeric materials discussed herein or other polymeric materials.

Advantageously, the reinforcements, constructions, structures, the adhesive or other attachments of the assembly or combinations thereof of the panel assembly can at least assist in providing desirable properties to the assembly and/or an automotive vehicle. For example, noise, vibration and harshness characteristics along with strength and stiffness characteristics may be improved. As an additional advantage, the structures and constructions of the instrument panel assembly can be separated and recycled particularly after use in an automotive vehicle.

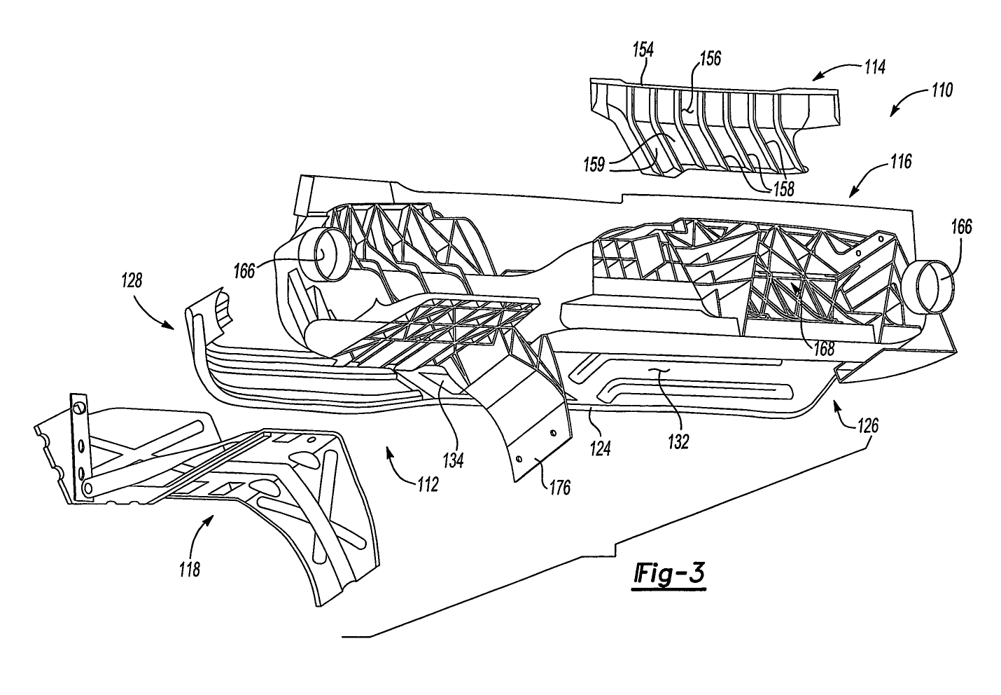

As discussed, the configuration of the various components of the instrument panel assembly may be varied within the scope of the present invention. For exemplary purposes, FIGS. 3, 4, 5 and 6A-6C illustrate two alternative assemblies formed in accordance with the present invention. Although the assemblies of FIGS. 3, 4, 5 and 6A-6C are different than the assembly of FIGS. 1-2B, the skilled artisan will understand that many, if not all, of the discussions relating to FIGS. 1-2B can be equally applied to the embodiments of FIGS. 3, 4, 5 and 6A-6C. Thus, as examples, discussions of the materials, the methods of formation, methods of use and operation, the physical shape, combinations thereof or the like of the assembly (e.g., the structures and constructions) of FIGS. 1-2B may also be applied to the assemblies (e.g., the structures and constructions) of FIGS. 3, 4, 5 and 6A-6C.

Referring to FIG. 3, there is illustrated at least a portion of an exemplary instrument panel assembly 110 in accordance with the present invention. The assembly 110 illustrated includes a first framework structure 112, a second framework structure 114, a construction 116 and a support structure 118.

In the embodiment shown, the first framework structure 112 includes an elongated member 124 extending from a first end 126 to a second end 128. The member 124 is designed to substantially extend from adjacent one A-pillar of an automotive vehicle to adjacent an opposite A-pillar of the vehicle, although not required. Moreover, the member 124 defines a channel 132 that is substantially coextensive with the member 124. In the embodiment shown, the channel 132 extends substantially horizontally into the member 124 as opposed to substantially vertically as does the channel 32 of the member 24 shown in FIG. 1. The member 124 is also configured with an opening 134 for allowing fluid flow (e.g., airflow) therethrough.

The second framework structure 114 is a generally elongated member 154 but may be otherwise configured to include other structures as well. As shown, the elongated member 154 of the second framework structure 114 defines a channel 156 in a manner similar to the elongated member 124 of the first structure 112. Additionally, the elongated member 124 includes a plurality of divider members 158 diving the channel 156 into sub-channels 159 (e.g., vertically extending sub-channels).

The first construction 116 is generally elongated and extends between a first end 162 and a second end 164. In one embodiment, the first construction includes a panel portion 168. As shown, the panel portion 160 includes a plurality of openings 172 at one each of the opposite ends 162, 164. The construction also include an extension 176 configured to be attached to a support column (e.g., a steering support column).

It is contemplated that the first and second structures and the first and second constructions may be formed of a variety of different materials. In a preferred embodiment the construction 116 is formed of one of the polymeric materials discussed above and the support 118 and framework structures 112, 114 are formed of one of the metal materials discussed above.

The components (i.e., the structures 112, 114, the support 118 and the construction 116 or any combination thereof) may be attached to each other using any of the fasteners and/or fastening techniques discussed above. In a preferred embodiment, the components are adhered to each other by applying adhesive to mating or corresponding surfaces of the components as described with reference to FIGS. 1-2B. Upon assembly, the channels 132, 156, 159 of the framework structures 110, 112 cooperatively form HVAC ducts with the construction 116.

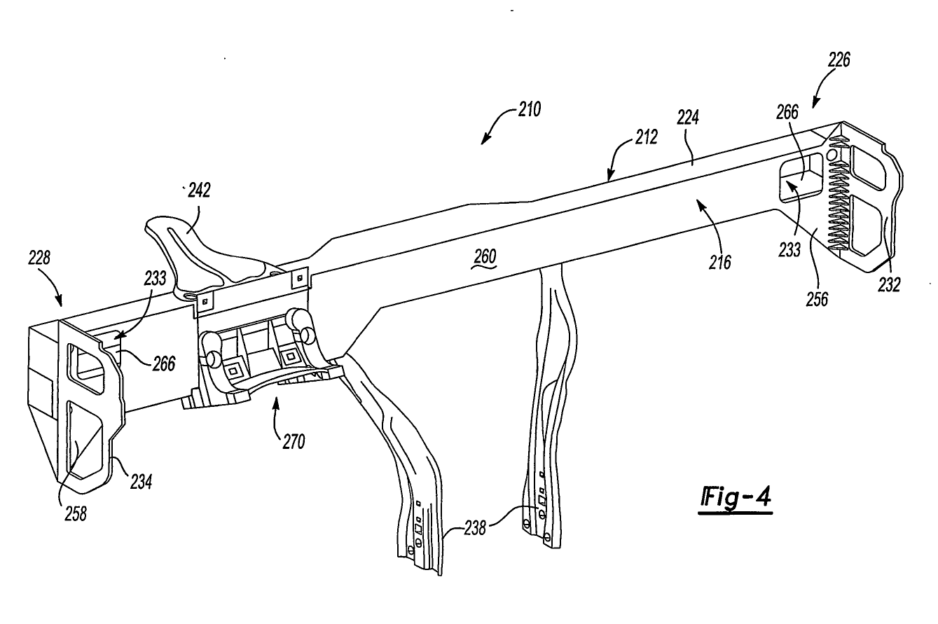

Referring to FIG. 4, there is illustrated at least a portion of an exemplary instrument panel assembly 210 in accordance with the present invention. The assembly 210, as illustrated, includes a framework structure 212 and a construction 216.

In the embodiment shown, the framework structure 212 includes an elongated member 224 extending from a first end 226 to a second end 228. The member 224 may be designed to substantially extend from adjacent one A-pillar of an automotive vehicle to adjacent an opposite A-pillar of the vehicle, although not required. Optionally, the member 224 may include attachments 232, 234 respectively at the opposite ends 226, 228 of the member 224 for attaching to vehicle components such as the A-pillars.

Preferably, the member 224 defines a channel 232 that is substantially coextensive with the member 224. In the embodiment shown, the channel 232 extends substantially horizontally into the member 224 as opposed to substantially vertically as in the channel 32 of the member 24 shown in FIG. 1. The member 224 is also typically configured with an opening (not shown) for allowing fluid flow (e.g., airflow) therethrough.

A pair of support members 238 extend from a lower portion of the framework structure 212. Moreover, a bracket 242, which is preferably configured for attachment to a vehicle component such as a firewall, is attached to an upper portion of the framework structure 212.

The construction 216 is generally elongated and extends between a first end 256 and a second end 258. In one embodiment, the first construction includes a panel portion 260. As shown, the panel portion 160 includes a plurality of openings 266, one at each of the opposite ends 256, 258.

The assembly 210 further includes a support 270 attached to the structure 212, the construction 216 or both Preferably, the support 270 is configured for attachment to a component of the vehicle such as steering column. It is contemplated that the structure 212, constructions 216, the supports 238, 270 and the bracket 242 may be formed of a variety of different materials. In a preferred embodiment the construction 216 is formed of one of the polymeric materials discussed above and the bracket 242, the supports 238, 270 and framework structure 212 is formed of one of the metal materials discussed above.

The components (i.e., the structure 212, the bracket 242, the supports 238, 270 and the construction 216 or any combination thereof) may be attached to each other using any of the fasteners and/or fastening techniques discussed above. In a preferred embodiment, the structure and construction are adhered to each other by applying adhesive to mating or corresponding surfaces of the components as described with reference to FIGS. 1-2B. Upon assembly, the channel 233 of the framework structure 212 cooperatively form at least one HVAC duct with the construction 216.

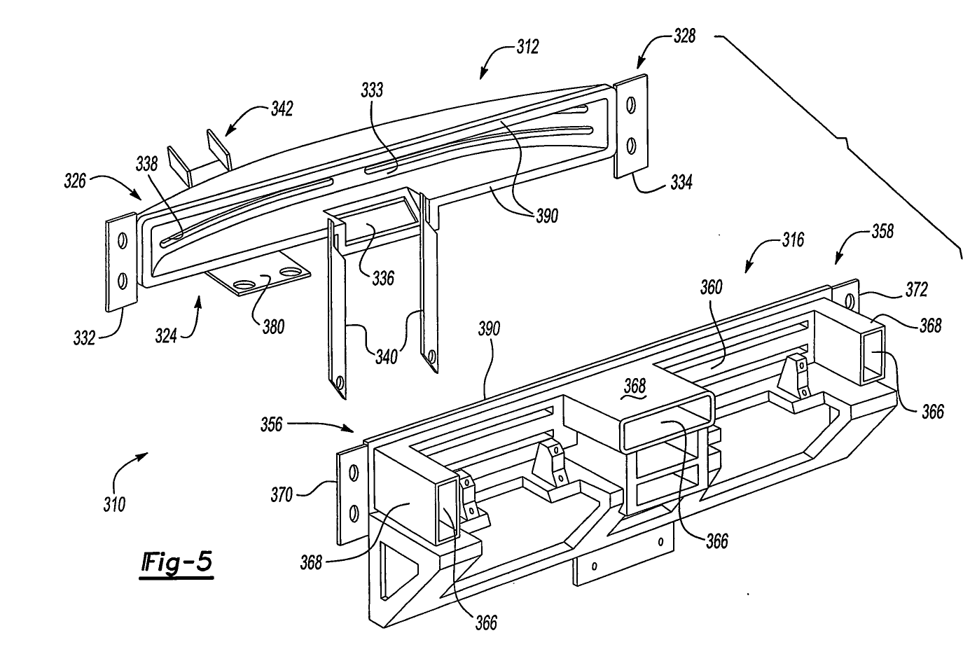

Referring to FIG. 5, there is illustrated an exemplary instrument panel assembly 310 in accordance with the present invention. The assembly 310, as illustrated, includes a framework structure 312 and a construction 316. In the embodiment shown, the assembly includes only one framework structure and only one construction, although not required.

In the embodiment shown, the framework structure 312 includes an elongated member 324 extending from a first end 326 to a second end 328. The member 324 may be designed to substantially extend from adjacent one A-pillar of an automotive vehicle to adjacent an opposite A-pillar of the vehicle, although not required. Optionally, the member 324 may include attachments 332, 334 respectively at the opposite ends 326, 328 of the member 324 for attaching to vehicle components such as the A-pillars.

Preferably, the member 324 defines a channel 333 that is substantially coextensive with the member 324. In the embodiment shown, the channel 333 extends substantially horizontally into the member 324 as opposed to substantially vertically as in the channel 32 of the member 24 shown in FIG. 1. The member 324 is also typically configured with an opening 336 for allowing fluid flow (e.g., airflow) therethrough. It can also be seen that a backwall 338 of the member 324 is generally continuously arcuate along the length of the member 324.

A pair of support members 340 extend from a lower portion of the framework structure 312. Moreover, a bracket 342, which is preferably configured for attachment to a vehicle component such as a firewall, is attached to an upper portion of the framework structure 312.

The construction 316 is generally elongated and extends between a first end 356 and a second end 358. In one embodiment, the construction 316 includes a panel portion 360. As shown, the panel portion 360 includes a plurality of openings 366, one at each of the opposite ends 356, 358 and one located substantially centrally along the length of the panel portion 360 between the ends 356, 358. As shown, the openings 366 are formed by tubular structures 368, that extend outward from the panel portion 360. The construction 316 also includes attachments 370, 372 corresponding to the attachments 332, 334 of the structure 312. As shown, the attachments 332, 334 extend from the opposite ends 356, 358 of the construction 316.

The assembly 310 further includes a support 380 attached to the structure 312, the construction 316 or both Preferably, the support 380 is configured for attachment to a component of the vehicle such as steering column. It is contemplated that the structure 312, construction 316, the supports 340, 380 and the bracket 342 may be formed of a variety of different materials. In a preferred embodiment the construction 316 is formed of one of the polymeric materials discussed above and the bracket 342, the attachments 332, 334, 370, 372, the supports 340, 380 and framework structure 312 are formed of one of the metal materials discussed above.

The components (i.e., the structure 312, the bracket 342, the supports 340, 380 and the construction 316 or any combination thereof) may be attached to each other using any of the fasteners and/or fastening techniques discussed above. In a preferred embodiment, the structure 312 and construction 316 are adhered to each other by applying adhesive to mating or corresponding surfaces 390 of the components as described with reference to FIGS. 1-2B. Upon assembly, the channel 333 of the framework structure 312 cooperatively form at least one HVAC duct with the construction 316.

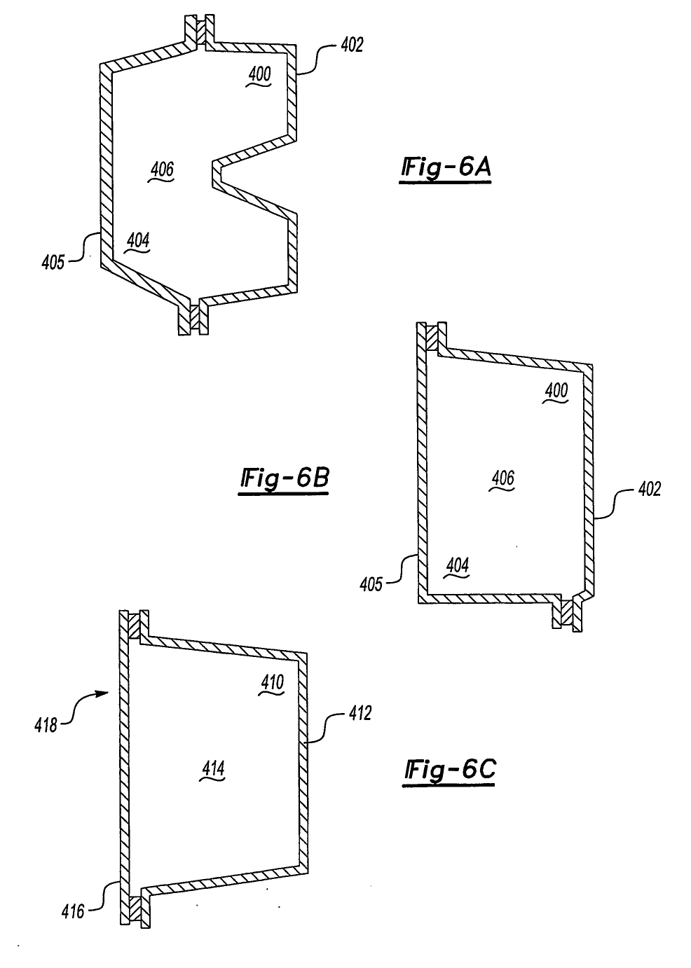

It should be understood that the ducts of the instrument panel assembly may be formed from one or more channels in the constructions as well as the channels in the structures. In FIGS. 6A-6B a channel 400 formed in a construction 402 combines with a channel 404 in a framework structure 405 to form a duct 406. In FIG. 6C, a channel 410 in a construction 412 cooperatively forms a duct 414 with a panel portion 416 of a framework structure 418.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims. In particular regard to the various functions performed by the above described components, assemblies, devices, compositions, etc., the terms used to describe such items are intended to correspond, unless otherwise indicated, to any item that performs the specified function of the described item, even though not necessarily structurally equivalent to the disclosed structure. In addition, while a particular feature of the invention may have been described above with respect to only one of the embodiments, such feature may be combined with one or more other features of other illustrated embodiments.

1-21. (canceled)

22. A method of forming an instrument panel assembly, comprising:
providing a first framework structure formed of a first material, the first framework structure providing a corresponding surface formed of the first material;
providing a first construction formed of a second material, the first construction providing a corresponding surface formed of the second material;
adhering the corresponding surface of the first structure to the corresponding surface of the first construction with an adhesive.

23. A method according to claim 1 wherein at least one of the corresponding surface of the first framework structure and the corresponding surface of the first construction is a low energy surface and wherein the adhesive is capable of bonding to the low energy surface.

24. A method according to claim 2 wherein the low energy surface is provided by the first construction and the first material is a plastic having a surface energy of less than 45 mJ/m².

25. A method according to claims 3 wherein the plastic is selected from short glass fibre filled polypropylene, long glass fibre filled polypropylene, glass filled polyamide and glass filled polyamide alloys.

26. A method according to claim 3 further comprising applying the adhesive directly to the corresponding surface of the first construction without treatment or priming of the said corresponding surface of the first construction.

27. A method according to claim 3 wherein the first construction and the corresponding surface of the first construction is formed of polypropylene or polyamide.

28. A method according to claim 2 wherein the adhesive comprises an organoborane/amine complex and one or more of monomers, oligomers or polymers having olefinic unsaturation which is capable of polymerization by free radical polymerization.

29. A method according to claim 7 in which the polymerizable composition further comprises a compound which causes the complex to disassociate so as to release the organoborane to initiate polymerization of one or more of monomers, oligomers or polymers having olefinic unsaturation.

30. A method according to claim 7 wherein the amine part of the organoborane/amine complex is selected from the group of amines having an amidine structural component; aliphatic heterocycles having at least one nitrogen in the heterocyclic ring; primary amines which in addition have one or more hydrogen bond accepting groups wherein there are at least two carbon atoms between the primary amine and the hydrogen bond accepting group; and conjugated imines.

31. A method according to claim 7 wherein the amine is selected from dimethylaminopropyl amine, methoxypropyl amine, dimethylaminoethylamine, dimethylaminobutylamine, methoxybutyl amine, methoxyethyl amine, ethoxypropylamine, propoxypropylamine, amine terminated polyalkylene ethers (such as trimethylolpropane tris(poly(propyleneglycol), amine terminated)ether), aminopropylmorpholine, isophoronediamine, and aminopropylpropanediamine.

32. A method of forming an instrument panel assembly, comprising:
providing a first framework structure formed of a first material, the first framework structure providing a corresponding surface formed of the first material, wherein:
i. the first material is a metal; and
ii. the the first structure includes an elongated member that substantially extends from one A-pillar of an automotive vehicle to another A-pillar of the automotive vehicle;
providing a first construction formed of a second material, the first construction providing a corresponding surface formed of the second material, wherein:
i. the second material is a polymeric material; and
adhering the corresponding surface of the first structure to the corresponding surface of the first construction with an adhesive, wherein:
i. the first structure and the first construction cooperatively define at least one duct after the adhering step; and
ii. the duct provides fluid communication between a supply of conditioned air and an opening that is at least partially defined by a front panel portion of the first construction.

33. A method according to claim 11 wherein the first structure includes a structure for supporting a steering wheel column.

34. A method as in any of claim 11 wherein a covering is disposed upon a surface of the first construction.

35. A method as in claim 13 wherein the covering is formed of a blow molded polymeric material.

36. A method according to claim 11 wherein the polymeric material comprises a homopolymer selected from a polyolefin, a polystyrene and a polyamide or a copolymer thereof.

37. A method according to claim 11 wherein the polymeric material comprises a polymer selected from a polystyrene alloy, a polybutylene terephthalate polymer, a acrylonitrile butadiene styrene, a polycarbonate acrylonitrile butadiene styrene, a styrene maleic anhydride, polyphenylene ether, polyphenylene oxide, a combination thereof or the like.

38. A method according to claim 11 wherein the polymeric material includes a fiber selected from short glass fiber, long glass fiber, short natural fiber or long natural fiber.

39. A method according to claim 11 wherein the first framework structure and it corresponding surface is made of a metal selected from steel, aluminium or a combination thereof.

40. A method according to claim 11 wherein the adhesive is comprised of a urethane, an acrylic, a methyl methacrylate, an epoxy, an acrylonitrile butadiene styrene, a polycarbonate or a mixture thereof.

41. A method according to claim 11, further comprising:
providing a second framework structure;
providing a second construction;
adhering the second framework structure to the second construction; and adhering at least on of the second framework structure and the second construction or both to the second construction.

42. A method of forming an instrument panel assembly, comprising:
providing a first framework structure formed of a first material, the first framework structure providing a corresponding surface formed of the first material, wherein:
i. the first material is a metal; and
ii. the the first structure includes an elongated member that substantially extends from one A-pillar of an automotive vehicle to another A-pillar of the automotive vehicle;
iii. the first framework structrure defines a channel;
providing a first construction formed of a second material, the first construction providing a corresponding surface formed of the second material, wherein:
i. the second material is a polymeric material;
ii. at least one of the corresponding surface of the first framework structure and the corresponding surface of the first construction is a low energy surface of less than 45 mJ/m²;
adhering the corresponding surface of the first structure to the corresponding surface of the first construction with an adhesive, wherein:
i. the first structure and the first construction cooperatively define at least one duct after the adhering step, the duct being at least partially formed by the channel of the first framework structure;
ii. the duct provides fluid communication between a supply of conditioned air and an opening that is at least partially defined by a front panel portion of the first construction; and
iii. the adhesive comprises an organoborane/amine complex and one or more of monomers, oligomers or polymers having olefinic unsaturation which is capable of polymerization by free radical polymerization and the organoborane part of the organoborane/amine complex is selected from a trialkyl borane and an alkyl cycloalkyl borane.
